(19) United States
(12) Patent Application Publication
(10) Pub. No.: US 2026/0020077 A1
(43) Pub. Date: Jan. 15, 2026

(54) WIRELESS COMMUNICATION METHOD OF INTER-CELL MOBILITY AND USER EQUIPMENT

(71) Applicant: GUANGDONG OPPO MOBILE TELECOMMUNICATIONS CORP., LTD., Dongguan (CN)

(72) Inventor: Li GUO, Allen, TX (US)

(21) Appl. No.: 19/333,276

(22) Filed: Sep. 18, 2025

Related U.S. Application Data
(63) Continuation of application No. PCT/CN2024/089084, filed on Apr. 22, 2024.
(60) Provisional application No. 63/524,172, filed on Jun. 29, 2023.

(51) Int. Cl. H04W 74/0833; H04W 72/232

(52) U.S. Cl. CPC H04W 74/0833; H04W 72/232

(57) ABSTRACT

A wireless communication method of inter-cell mobility, by a user equipment (UE) includes receiving, from a base station, a configuration of a list of candidate cells for inter-cell mobility, receiving, from the base station, a random access channel (RACH) configuration of each candidate cell in the list of candidate cells, and receiving, from the base station, a signaling used to indicate the UE to perform a physical random access channel (PRACH) preamble transmission to a candidate cell in the list of candidate cells.

### CROSS REFERENCE TO RELATED APPLICATION(S)

This application is a continuation of International Application No. PCT/CN2024/089084, filed Apr. 22, 2024, which claims priority to U.S. Provisional Application No. 63/524,172, filed Jun. 29, 2023, the entire disclosures of which are incorporated herein by reference.

### TECHNICAL FIELD

The present disclosure relates to the field of communication systems, and more particularly, to wireless communication methods of inter-cell mobility and a user equipment (UE).

### BACKGROUND

The drawback of current inter-cell mobility design in new radio (NR) is undesirable latency and signaling overhead. This impairs a system performance of high mobility user equipments (UEs). In particular, the current physical downlink control channel (PDCCH)-order physical random access channel (PRACH) cannot trigger a user equipment (UE) to transmit a PRACH preamble to a non-serving cell. Therefore, when the UE is connected with a serving cell, the UE cannot send a PRACH to the non-serving cell. The consequence is that the UE would have to perform a random access procedure to the non-serving cell when the UE is indicated to switch to that cell and a latency of switching cell is enlarged.

Therefore, there is a need for apparatuses and wireless communication methods of inter-cell mobility.

### SUMMARY

In a first aspect of the present disclosure, a wireless communication method of inter-cell mobility, by a user equipment (UE), includes receiving, from a base station, a configuration of a list of candidate cells for inter-cell mobility, receiving, from the base station, a random access channel (RACH) configuration of each candidate cell in the list of candidate cells, and receiving, from the base station, a signaling used to indicate the UE to perform a physical random access channel (PRACH) preamble transmission to a candidate cell in the list of candidate cells.

In a second aspect of the present disclosure, a wireless communication method of inter-cell mobility, by a base station, includes transmitting, to a user equipment (UE), a configuration of a list of candidate cells for inter-cell mobility, transmitting, to the UE, a random access channel (RACH) configuration of each candidate cell in the list of candidate cells, and transmitting, to the UE, a signaling used to indicate the UE to perform a physical random access channel (PRACH) preamble transmission to a candidate cell in the list of candidate cells.

In a third aspect of the present disclosure, a UE includes a memory, a transceiver, and a processor coupled to the memory and the transceiver. The UE is configured to perform the method in the first aspect.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a flowchart illustrating an example of a wireless communication method of inter-cell mobility.

FIG. 2 is a block diagram of one or more user equipments (UEs) and a base station of communication in a communication network system according to an embodiment of the present disclosure.

FIG. 3 is a block diagram of a UE according to an embodiment of the present disclosure.

FIG. 4 is a block diagram of a UE according to an embodiment of the present disclosure.

FIG. 5 is a flowchart illustrating a wireless communication method of inter-cell mobility performed by a UE according to an embodiment of the present disclosure.

FIG. 6 is a block diagram of a base station according to an embodiment of the present disclosure.

FIG. 7 is a block diagram of a base station according to an embodiment of the present disclosure.

FIG. 8 is a flowchart illustrating a wireless communication method of inter-cell mobility performed by a base station according to an embodiment of the present disclosure.

FIG. 9 is a flowchart illustrating a wireless communication method of inter-cell mobility according to an embodiment of the present disclosure.

FIG. 10 is a block diagram of an example of a computing device according to an embodiment of the present disclosure.

FIG. 11 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

The technical solutions of the embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD) system, an advanced long term evolution (LTE-A) system, a new radio (NR) system, an evolution system of a NR system, a LTE-based access to unlicensed spectrum (LTE-U) system, a NR-based access to unlicensed spectrum (NR-U) system, an universal mobile telecommunication system (UMTS), a global interoperability for microwave access (WiMAX) communication system, wireless local area networks (WLAN), wireless fidelity (Wi-Fi), a future 5th generation (5G) system (may also be called a new radio (NR) system) or other communication systems, etc.

Optionally, a base station mentioned in the embodiments of the present application can provide a communication coverage for a specific geographic area and can communicate with a user equipment (UE) located in the coverage area. Optionally, the base station may be a gNB, a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN).

A user equipment (UE) may refer to an access terminal, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), a handheld device with wireless communication functions, a computing device, other processing devices coupled with a wireless modem, an in-vehicle device, a wearable device, a terminal device in a future 5G network, a terminal device in a future evolved public land mobile network (PLMN), etc.

Optionally, the communication system in the embodiment of the present application may be applied to an unlicensed spectrum, where the unlicensed spectrum may also be considered as a shared spectrum; or the communication system in the embodiment of the present application may also be applied to a licensed spectrum, where the licensed spectrum can also be considered an unshared spectrum.

NR/5G system supports a physical downlink control channel (PDCCH)-order physical random access channel (PRACH) transmission. The PDCCH-order PRACH transmission is a mechanism by which a base station such as a gNB can order a user equipment (UE) to initiate a PRACH transmission. One example use case for this mechanism is when the gNB finds timing between the gNB and the UE that needs further improvement, the gNB can order the UE to transmit a PRACH, and then the gNB can measure the uplink timing. In the NR/5G system, the gNB use a downlink control information (DCI) format 0_1 to trigger the PDCCH-order PRACH transmission. The basic procedure is illustrated in FIG. 1, FIG. 1 illustrates that, in some examples, the basic procedure may include an operation 102, a gNB provides a configuration of PRACH to a UE, an operation 104, the gNB sends a DCI format 1_0 to trigger a PRACH transmission, an operation 106, the UE decodes the DCI format 1_0 and sends a PRACH preamble by following indication information indicated in the DCI format 1_0, an operation 108, the gNB detects the PRACH preamble, and an operation 110, the gNB sends a PRACH response to the UE.

In details, as illustrated in FIG. 1, the gNB first provides the configuration of PRACH to the UE. When the gNB needs the PRACH, for example, to refine the timing, the gNB can send the DCI format 1_0 to trigger the UE to transmit the PRACH. When the UE receives the DCI format 1_0 for PDCCH-order PRACH, the UE can choose the PRACH preamble by following the configuration provided by the gNB and then transmit the selected PRACH preamble in the corresponding PRACH resource. Then, the gNB detects the PRACH preamble, after which the gNB sends the response to the UE.

In some examples, the DCI format 1_0 that the gNB uses to trigger the PRACH transmission may include the following fields: random access preamble index used to indicate an index of a PRACH preamble that the UE may choose to transmit, uplink (UL)/supplementary uplink (SUL) indicator used to indicate which uplink carrier in a cell to transmit the PRACH, synchronization signal/physical broadcast channel (SS/PBCH) index used to indicate the SS/PBCH that may be used to determine the RACH occasion for the PRACH transmission, PRACH mask index used to indicate the RACH occasion associated with the SS/PBCH indicated by the SS/PBCH index for the PRACH transmission.

In the NR/5G system, the PDCCH-order PRACH can be used to trigger either a contention-based random access procedure or contention-free random access procedure.

The current PDCCH-order PRACH cannot trigger a UE to transmit a PRACH preamble to a non-serving cell. Therefore, when the UE is connected with a serving cell, the UE cannot send a PRACH to the non-serving cell. The consequence is that the UE would have to perform a random access procedure to the non-serving cell when the UE is indicated to switch to that cell and a latency of switching cell is enlarged.

To overcome these and other challenges, some embodiments of the present disclosure provide apparatuses and wireless communication methods of inter-cell mobility, which can solve issues in the prior art and other issues, reduce a latency of switching cell, reduce signaling overhead, and/or improve a performance of inter-cell mobility. For examples, some embodiments of the present disclosure provide a method for setting a power ramping of a PRACH preamble retransmission for PDCCH-order RACH transmission to a candidate cell during first layer/second layer (L1/L2) triggered mobility.

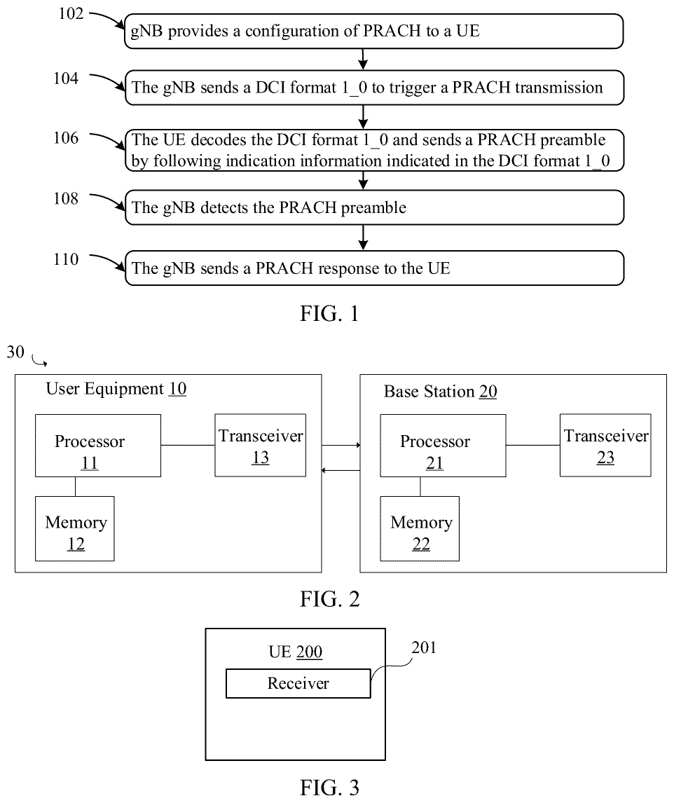

FIG. 2 illustrates that, in some embodiments, one or more user equipments (UEs) 10 and a base station (e.g., next generation NodeB (gNB) or eNB) 20 of communication in a communication network system 30 (e.g., an NR system) according to an embodiment of the present disclosure are provided. The communication network system 30 includes the one or more UEs 10 and the base station 20. The one or more UEs 10 may include a memory 12, a transceiver 13, and a processor 11 coupled to the memory 12 and the transceiver 13. The base station 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the transceiver 13 is configured to receive, from a base station, a configuration of a list of candidate cells for inter-cell mobility, receive, from the base station, a random access channel (RACH) configuration of each candidate cell in the list of candidate cells, and receive, from the base station, a signaling used to indicate the UE to perform a physical random access channel (PRACH) preamble transmission to a candidate cell in the list of candidate cells. This can solve issues in the prior art and other issues, reduce a latency of switching cell, reduce signaling overhead, and/or improve a performance of Inter-cell mobility.

In some embodiments, the transceiver 23 is configured to transmit, to a user equipment (UE), a configuration of a list of candidate cells for inter-cell mobility, transmit, to the UE, a random access channel (RACH) configuration of each candidate cell in the list of candidate cells, and transmit, to the UE, a signaling used to indicate the UE to perform a physical random access channel (PRACH) preamble transmission to a candidate cell in the list of candidate cells. This can solve issues in the prior art and other issues, reduce a latency of switching cell, reduce signaling overhead, and/or improve a performance of Inter-cell mobility.

FIG. 3 illustrates an example of a UE 200 according to an embodiment of the present application. The UE 200 is configured to implement some embodiments of the disclosure. Some embodiments of the disclosure may be implemented into the UE 200 using any suitably configured hardware and/or software. The UE 200 includes a receiver 201. The receiver 201 is configured to receive, from a base station, a configuration of a list of candidate cells for inter-cell mobility, receive, from the base station, a random access channel (RACH) configuration of each candidate cell in the list of candidate cells, and receive, from the base station, a signaling used to indicate the UE to perform a physical random access channel (PRACH) preamble transmission to a candidate cell in the list of candidate cells. This can solve issues in the prior art and other issues, reduce a latency of switching cell, reduce signaling overhead, and/or improve a performance of Inter-cell mobility.

FIG. 4 illustrates an example of a UE 300 according to an embodiment of the present disclosure. The UE 300 is configured to implement some embodiments of the disclosure. Some embodiments of the disclosure may be implemented into the UE 300 using any suitably configured hardware and/or software. The UE 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the transceiver 302 is configured to receive, from a base station, a configuration of a list of candidate cells for inter-cell mobility, receive, from the base station, a random access channel (RACH) configuration of each candidate cell in the list of candidate cells, and receive, from the base station, a signaling used to indicate the UE to perform a physical random access channel (PRACH) preamble transmission to a candidate cell in the list of candidate cells. This can solve issues in the prior art and other issues, reduce a latency of switching cell, reduce signaling overhead, and/or improve a performance of Inter-cell mobility.

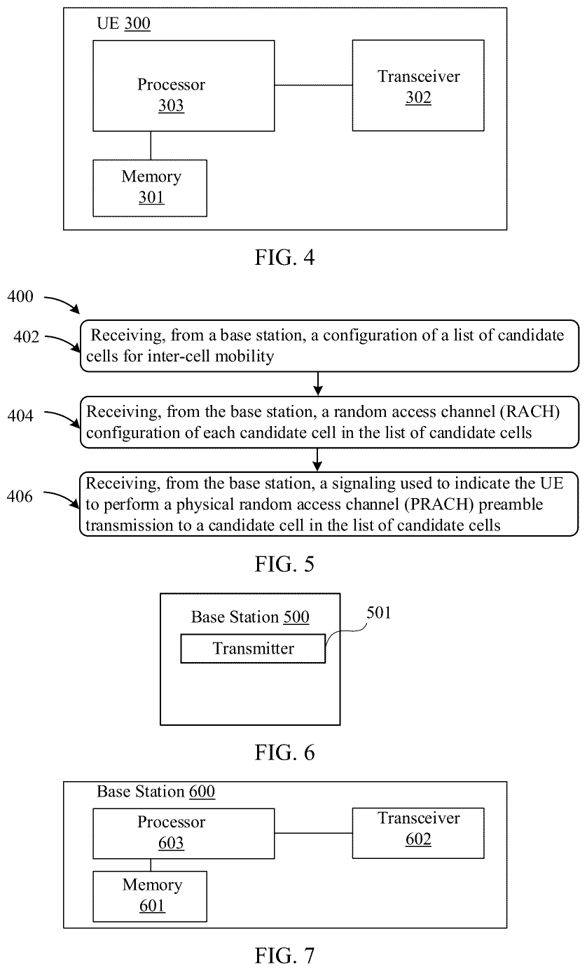

FIG. 5 is an example of a method 400 of inter-cell mobility performed by a UE according to an embodiment of the present disclosure. The method 400 of inter-cell mobility performed by a UE is configured to implement some embodiments of the disclosure. Some embodiments of the disclosure may be implemented into the method 400 of inter-cell mobility performed by a UE using any suitably configured hardware and/or software. In some embodiments, the method 400 of inter-cell mobility performed by a UE includes: an operation 402, receiving, from a base station, a configuration of a list of candidate cells for inter-cell mobility, an operation 404, receiving, from the base station, a random access channel (RACH) configuration of each candidate cell in the list of candidate cells, and an operation 406, receiving, from the base station, a signaling used to indicate the UE to perform a physical random access channel (PRACH) preamble transmission to a candidate cell in the list of candidate cells. This can solve issues in the prior art and other issues, reduce a latency of switching cell, reduce signaling overhead, and/or improve a performance of Inter-cell mobility.

In some embodiments, the signaling is a downlink control information (DCI) signaling and includes one or more of following information: an indicator used to indicate the candidate cell in the list of candidate cells, which the UE is indicated to transmit the PRACH preamble to, an indicator of a synchronization signal/physical broadcast channel (SS/PBCH) of a cell, an indicator of a random access preamble index, an indicator of a PRACH mask index, and an indicator used to indicate whether the PRACH preamble transmission is an initial transmission or a retransmission. In some embodiments, the DCI signaling is a DCI format 1_0 used for a random access procedure initiated by a physical downlink control channel (PDCCH)-order to the candidate cell in the list of candidate cells.

In some embodiments, the method further includes determining a power-ramping value associated with the PRACH preamble transmission. In some embodiments, the method further includes adjusting a power-ramping counter value based on the power-ramping value. In some embodiments, the method further includes calculating a transmit power of the PRACH preamble transmission, wherein the transmit power is calculated based on the power-ramping counter value. In some embodiments, the method further includes performing the PRACH preamble transmission using the transmit power to the candidate cell in the list of candidate cells.

FIG. 6 illustrates an example of base station 500 according to an embodiment of the present application. The base station 500 is configured to implement some embodiments of the disclosure. Some embodiments of the disclosure may be implemented into the base station 500 using any suitably configured hardware and/or software. The base station 500 includes a transmitter 501. The transmitter 501 is configured to transmit, to a user equipment (UE), a configuration of a list of candidate cells for inter-cell mobility, transmit, to the UE, a random access channel (RACH) configuration of each candidate cell in the list of candidate cells, and transmit, to the UE, a signaling used to indicate the UE to perform a physical random access channel (PRACH) preamble transmission to a candidate cell in the list of candidate cells. This can solve issues in the prior art and other issues, reduce a latency of switching cell, reduce signaling overhead, and/or improve a performance of Inter-cell mobility.

FIG. 7 illustrates an example of a base station 600 according to an embodiment of the present disclosure. The base station 600 is configured to implement some embodiments of the disclosure. Some embodiments of the disclosure may be implemented into the base station 600 using any suitably configured hardware and/or software. The base station 600 may include a memory 601, a transceiver 602, and a processor 603 coupled to the memory 601 and the transceiver 602. The processor 603 may be configured to implement proposed functions, procedures and/or methods described in this description. Layers of radio interface protocol may be implemented in the processor 603. The memory 601 is operatively coupled with the processor 603 and stores a variety of information to operate the processor 603. The transceiver 602 is operatively coupled with the processor 603, and the transceiver 602 transmits and/or receives a radio signal. The processor 603 may include application-specific integrated circuit (ASIC), other chipset, logic circuit and/or data processing device. The memory 601 may include read-only memory (ROM), random access memory (RAM), flash memory, memory card, storage medium and/or other storage device. The transceiver 602 may include baseband circuitry to process radio frequency signals. When the embodiments are implemented in software, the techniques described herein can be implemented with modules (e.g., procedures, functions, and so on) that perform the functions described herein. The modules can be stored in the memory 601 and executed by the processor 603. The memory 601 can be implemented within the processor 603 or external to the processor 603 in which case those can be communicatively coupled to the processor 603 via various means as is known in the art.

In some embodiments, the transceiver 602 is configured to transmit, to a user equipment (UE), a configuration of a list of candidate cells for inter-cell mobility, transmit, to the UE, a random access channel (RACH) configuration of each candidate cell in the list of candidate cells, and transmit, to the UE, a signaling used to indicate the UE to perform a physical random access channel (PRACH) preamble transmission to a candidate cell in the list of candidate cells. This can solve issues in the prior art and other issues, reduce a latency of switching cell, reduce signaling overhead, and/or improve a performance of Inter-cell mobility.

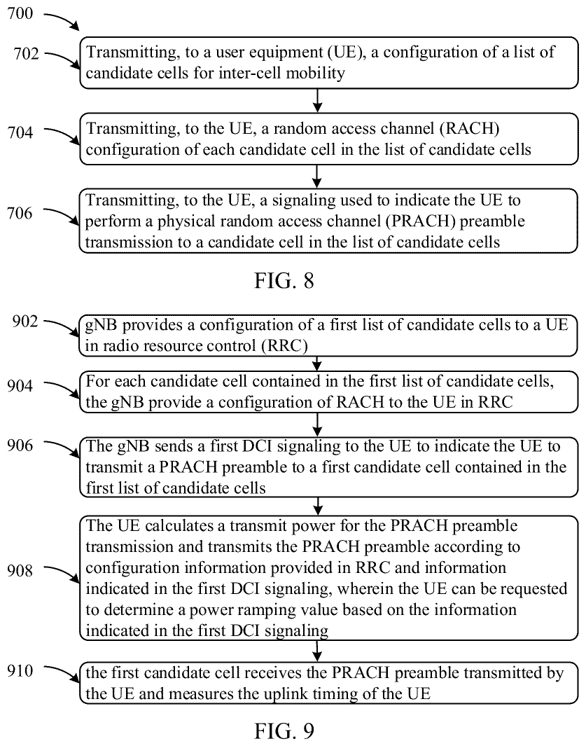

FIG. 8 is an example of a method 700 of inter-cell mobility performed by a base station according to an embodiment of the present disclosure. The method 700 of inter-cell mobility performed by the base station is configured to implement some embodiments of the disclosure. Some embodiments of the disclosure may be implemented into the method 700 of inter-cell mobility performed by the base station using any suitably configured hardware and/or software. In some embodiments, the method 700 of inter-cell mobility performed by the base station includes: an operation 702, transmitting, to a user equipment (UE), a configuration of a list of candidate cells for inter-cell mobility, an operation 704, transmitting, to the UE, a random access channel (RACH) configuration of each candidate cell in the list of candidate cells, and an operation 706, transmitting, to the UE, a signaling used to indicate the UE to perform a physical random access channel (PRACH) preamble transmission to a candidate cell in the list of candidate cells. This can solve issues in the prior art and other issues, reduce a latency of switching cell, reduce signaling overhead, and/or improve a performance of Inter-cell mobility.

In some embodiments, the signaling is a downlink control information (DCI) signaling and includes one or more of following information: an indicator used to indicate the candidate cell in the list of candidate cells, which the UE is indicated to transmit the PRACH preamble to, an indicator of a synchronization signal/physical broadcast channel (SS/PBCH) of a cell, an indicator of a random access preamble index, an indicator of a PRACH mask index, and an indicator used to indicate whether the PRACH preamble transmission is an initial transmission or a retransmission. In some embodiments, the DCI signaling is a DCI format 1_0 used for a random access procedure initiated by a physical downlink control channel (PDCCH)-order to the candidate cell in the list of candidate cells.

In some embodiments, the signaling used to indicate the UE to determine a power-ramping value associated with the PRACH preamble transmission. In some embodiments, the signaling used to indicate the UE to adjust a power-ramping counter value based on the power-ramping value. In some embodiments, the signaling used to indicate the UE to calculate a transmit power of the PRACH preamble transmission, wherein the transmit power is calculated based on the power-ramping counter value.

In some embodiments, the method further includes receiving the PRACH preamble transmission using the transmit power. In some embodiments, the method further includes measuring an uplink timing associated with the UE located in the candidate cell in the list of candidate cells based on the PRACH preamble transmission. In some embodiments, the method further includes initiating a cell-reselection procedure with the UE based on the uplink timing.

### Exemplary Technical Solutions:

In some embodiments, a serving gNB can provide a first list of candidate cell(s) to a UE, where the list of candidate cell(s) can be a list of candidate cells for inter-cell mobility. The gNB can also provide a RACH configuration for each cell contained in the first list of candidate cell(s). In other words, for one candidate cell contained in the first list of candidate cell(s), there is one configuration of RACH transmission. Then, the gNB can indicate a UE to transmit a PRACH preamble to a first candidate cell contained in the first list of candidate cell(s). The gNB can provide the configuration of PRACH of one or more candidate cells to the UE. The gNB can send a first DCI signaling to indicate the UE to transmit PRACH preamble to a first candidate cell.

In some examples, the first DCI signaling can contain one or more of the following information:

An indicator used to indicate a first candidate cell in the first list of candidate cell, which the UE is indicated to transmit the PRACH preamble to.

An indicator of a SS/PBCH of a cell. This field can indicate a SS/PBCH of a non-serving cell. The UE can be requested to use this indicated SS/PBCH to determine a RACH occasion for the PRACH transmission.

An indicator of a random access preamble index. This field can indicate one PRACH preamble for the UE to transmit.

An indicator of a PRACH mask index. This field can be used to indicate the RACH occasion for PRACH transmission.

A first indicator used to indicate whether the PRACH preamble transmission is an initial transmission or a retransmission. For examples, a bit field of the first indicator equal to a first value indicates that the PRACH preamble transmission is initial transmission, and a bit field of the first indicator equal to a second value indicates that the PRACH preamble transmission is a retransmission. In an example, a bit field of the first indicator equal to 0 indicates that the PRACH preamble transmission is initial transmission, and a bit field of the first indicator equal to 1 indicates that the PRACH preamble transmission is a retransmission. In another example, a bit field of the first indicator equal to 1 indicates that the PRACH preamble transmission is initial transmission, and a bit field of the first indicator equal to 0 indicates that the PRACH preamble transmission is a retransmission.

In some embodiments, when the UE receives the first DCI signaling, the UE can be requested to transmit a PRACH preamble according to the configuration information indicated by the first DCI signaling. In particular, the UE may calculate a transmit power of the PRACH preamble transmission according to the indication in the first DCI signaling.

FIG. 9 illustrates a procedure of transmitting a PRACH preamble to a candidate cell according to some methods presented in some embodiments of the present disclosure. FIG. 9 illustrates that, in some embodiments, the procedure may include an operation 902, a gNB provides a configuration of a first list of candidate cells to a UE in radio resource control (RRC) an operation 904, for each candidate cell contained in the first list of candidate cells, the gNB provide a configuration of RACH to the UE in RRC, an operation 906, the gNB sends a first DCI signaling to the UE to indicate the UE to transmit a PRACH preamble to a first candidate cell contained in the first list of candidate cells, an operation 908, the UE calculates a transmit power for the PRACH preamble transmission and transmits the PRACH preamble according to configuration information provided in RRC and information indicated in the first DCI signaling, wherein the UE can be requested to determine a power ramping value based on the information indicated in the first DCI signaling, and an operation 910, the first candidate cell receives the PRACH preamble transmitted by the UE and measures the uplink timing of the UE.

In some embodiments, the gNB can provide a list of candidate cell(s) for mobility to the UE and the gNB can also provide the RACH configuration for each of the candidate cell. The gNB can send one DCI format 1_0 to trigger the UE to transmit PRACH preamble to a first candidate cell. The DCI format 1_0 format is for random access procedure initiated by a PDCCH-order towards a candidate cell with all the following fields sets:

An indicator used to indicate one candidate cell in the first list of candidate cells. This field can indicate a non-serving cell in the first list of candidate cells to which the UE is indicated to transmit a PRACH preamble. In some examples, the size of this field can be zero if the UE is not configured with L1/L2 triggered mobility. In some examples, the size of this field can be N bits if the UE is configured with L1/L2 triggered mobility. In some examples, the size of this field can be N bits if the UE is provided with the first list of candidate cells and the size of N=┌log₂ (L+1)┐, where L is the number of cells configured in the first list of candidate cells.

An indicator of a SS/PBCH of a cell. This field can indicate a SS/PBCH of a non-serving cell. The UE can be requested to use this indicated SS/PBCH to determine a RACH occasion for the PRACH transmission.

An indicator of a random-access preamble index. This field can indicate one PRACH preamble for the UE to transmit.

An indicator of a PRACH mask index. This field can be used to indicate the RACH occasion for PRACH transmission.

A first indicator used to indicate the index of the order of the PRACH preamble transmission. For examples, the value of this indicator equal a first value can indicate this is the initial PRACH preamble transmission, and the value of this indicator equal to a second value can indicate this is a retransmission of the PRACH preamble. In some examples, the value of this indicator equal 0 can indicate this is the initial PRACH preamble transmission, and the value of this indicator equal to 1 can indicate this is a retransmission of the PRACH preamble. In some examples, the value of this indicator equal 1 can indicate this is the initial PRACH preamble transmission, and the value of this indicator equal to 0 can indicate this is a retransmission of the PRACH preamble.

In some examples, when the UE receives a first DCI format 1_0 triggering a PRACH preamble transmission to a first candidate cell, the UE can be requested to calculate a parameter for a transmit power of the PRACH preamble according to one or more of the followings:

In some examples, if the first indicator in the first DCI format 1_0 indicates that the PRACH preamble transmission is an initial transmission, the UE can be requested to set the parameter PREAMBLE_POWER_RAMPING_COUNTER for the first candidate cell to 1.

In some examples, if the first indicator in the first DCI format 1_0 indicates that the PRACH preamble transmission is a retransmission, the UE can be requested to increment the parameter PREAMBLE_POWER_RAMPING_COUNTER for the first candidate cell by 1.

In some examples, if the first indicator in the first DCI format 1_0 indicates that the PRACH preamble transmission is a retransmission, and if SSB selected by the first DCI format 1_0 is not changed from the selection in the last DCI format 1_0 that triggered PRACH preamble transmission to the first candidate cell, the UE can be requested to increment the parameter PREAMBLE_POWER_RAMPING_COUNTER for the first candidate cell by 1.

In some examples, if the first indicator in the first DCI format 1_0 indicates that the PRACH preamble transmission a is retransmission, and if the parameter PREAMBLE_POWER_RAMPING_COUNTER for the first candidate cell does not exist, the UE can be requested to set the parameter PREAMBLE_POWER_RAMPING_COUNTER for the first candidate cell to 1.

In some examples, if the first indicator in the first DCI format 1_0 indicates that the PRACH preamble transmission is a retransmission, and if the parameter PREAMBLE_POWER_RAMPING_COUNTER for the first candidate cell does not exist, the UE can be requested to set the parameter PREAMBLE_POWER_RAMPING_COUNTER for the first candidate cell to 1 and increment the parameter PREAMBLE_POWER_RAMPING_COUNTER for the first candidate cell by 1.

In some examples, if the first indicator in the first DCI format 1_0 indicates that the PRACH preamble transmission is a retransmission, and if the UE does not receive any DCI format 1_0 that triggered PRACH preamble to the first candidate cell before that, the UE can be requested to set the parameter PREAMBLE_POWER_RAMPING_COUNTER for the first candidate cell to 1.

In some examples, if the first indicator in the first DCI format 1_0 indicates that the PRACH preamble transmission is a retransmission, and if the UE does not receive any DCI format 1_0 that triggered PRACH preamble to the first candidate cell before that, the UE can be requested to set the parameter PREAMBLE_POWER_RAMPING_COUNTER for the first candidate cell to 1 and increment the parameter PREAMBLE_POWER_RAMPING_COUNTER for the first candidate cell by 1.

In some embodiments, for each preamble transmission, the UE can be requested to set the preamble received target power as follows: preamble ReceivedTargetPower+DELTA_PREAMBLE+ (the value of the first indicator)× PREAMBLE_POWER_RAMPING_STEP+POWER_OFFSET_2STEP_RA. Then the UE can be requested to calculate the transmit power of the PRACH preamble based on the determined preamble received target power and then transmit the PRACH preamble according to the indication information contained in the DCI format 1_0.

Technical Benefits: In some embodiments, the proposed method can enable the system to set a proper transmit power for a PRACH preamble transmission to a candidate cell. And thus it can improve the performance of PRACH preamble transmission for L1/L2 triggered mobility and reduce the latency of inter-cell mobility. Before switching to the target cell (which is a non-serving cell), the serving cell gNB can trigger the UE to transmit PRACH to the target cell so that the uplink timing to that non-serving cell can be obtained before the UE switches to the target cell.

Commercial interests for some embodiments are as follows. 1. Solve issues in the prior art and other issues. 2. Reduce a latency of switching cell. 3. Reduce signaling overhead. 4. Improve a performance of Inter-cell mobility. 5. Provide a good communication performance. 6. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of inter-cell mobility are considered for standardizing.

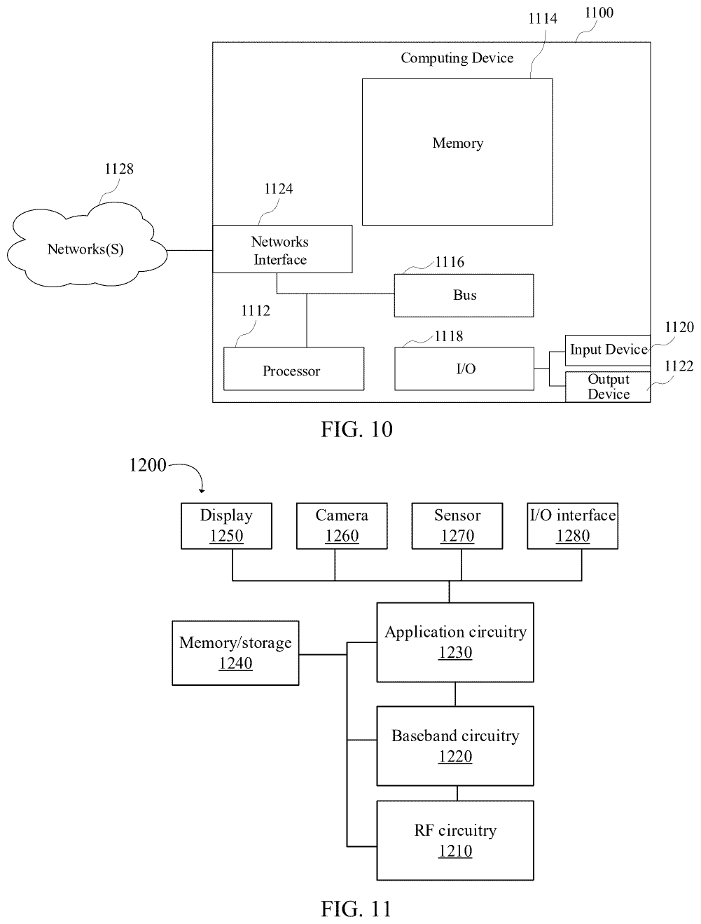

FIG. 10 is an example of a computing device 1100 according to an embodiment of the present disclosure. Any suitable computing device can be used for performing the operations described herein. For example, FIG. 10 illustrates an example of the computing device 1100 that can implement some embodiments of FIG. 2 to FIG. 9 using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium.

The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 2 to FIG. 9. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 11 is a block diagram of an example of a communication system 1200 according to an embodiment of the present disclosure. Embodiments described herein may be implemented into the communication system 1200 using any suitably configured hardware and/or software. FIG. 11 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 2 to FIG. 9. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 2 to FIG. 9 may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A wireless communication method of inter-cell mobility, by a user equipment (UE), comprising:
receiving, from a base station, a configuration of a list of candidate cells for inter-cell mobility;
receiving, from the base station, a random access channel (RACH) configuration of each candidate cell in the list of candidate cells; and
receiving, from the base station, a signaling used to indicate the UE to perform a physical random access channel (PRACH) preamble transmission to a candidate cell in the list of candidate cells.

2. The method of claim 1, wherein the signaling is a downlink control information (DCI) signaling and comprises one or more of following information:
an indicator used to indicate the candidate cell in the list of candidate cells, which the UE is indicated to transmit the PRACH preamble to;
an indicator of a synchronization signal/physical broadcast channel (SS/PBCH) of a cell;
an indicator of a random access preamble index;
an indicator of a PRACH mask index; and
an indicator used to indicate whether the PRACH preamble transmission is an initial transmission or a retransmission.

3. The method of claim 2, wherein the DCI signaling is a DCI format 1_0 used for a random access procedure initiated by a physical downlink control channel (PDCCH)-order to the candidate cell in the list of candidate cells.

4. The method of claim 1, further comprising determining a power-ramping value associated with the PRACH preamble transmission.

5. The method of claim 4, further comprising adjusting a power-ramping counter value based on the power-ramping value.

6. The method of claim 5, further comprising calculating a transmit power of the PRACH preamble transmission, wherein the transmit power is calculated based on the power-ramping counter value.

7. The method of claim 6, further comprising performing the PRACH preamble transmission using the transmit power to the candidate cell in the list of candidate cells.

8. A wireless communication method of inter-cell mobility, by a base station, comprising:
transmitting, to a user equipment (UE), a configuration of a list of candidate cells for inter-cell mobility;
transmitting, to the UE, a random access channel (RACH) configuration of each candidate cell in the list of candidate cells; and
transmitting, to the UE, a signaling used to indicate the UE to perform a physical random access channel (PRACH) preamble transmission to a candidate cell in the list of candidate cells.

9. The method of claim 8, wherein the signaling is a downlink control information (DCI) signaling and comprises one or more of following information:
an indicator used to indicate the candidate cell in the list of candidate cells, which the UE is indicated to transmit the PRACH preamble to;
an indicator of a synchronization signal/physical broadcast channel (SS/PBCH) of a cell;
an indicator of a random access preamble index;
an indicator of a PRACH mask index; and
an indicator used to indicate whether the PRACH preamble transmission is an initial transmission or a retransmission.

10. The method of claim 9, wherein the DCI signaling is a DCI format 1_0 used for a random access procedure initiated by a physical downlink control channel (PDCCH)-order to the candidate cell in the list of candidate cells.

11. The method of claim 8, wherein the signaling used to indicate the UE to determine a power-ramping value associated with the PRACH preamble transmission.

12. The method of claim 11, wherein the signaling used to indicate the UE to adjust a power-ramping counter value based on the power-ramping value.

13. The method of claim 12, wherein the signaling used to indicate the UE to calculate a transmit power of the PRACH preamble transmission, wherein the transmit power is calculated based on the power-ramping counter value.

14. The method of claim 13, further comprising receiving the PRACH preamble transmission using the transmit power.

15. The method of claim 14, further comprising measuring an uplink timing associated with the UE located in the candidate cell in the list of candidate cells based on the PRACH preamble transmission.

16. The method of claim 15, further comprising initiating a cell-reselection procedure with the UE based on the uplink timing.

17. A user equipment (UE), comprising:
a memory;
a transceiver; and
a processor coupled to the memory and the transceiver;
wherein the UE is configured to:
receive, from a base station, a configuration of a list of candidate cells for inter-cell mobility;
receive, from the base station, a random access channel (RACH) configuration of each candidate cell in the list of candidate cells; and
receive, from the base station, a signaling used to indicate the UE to perform a physical random access channel (PRACH) preamble transmission to a candidate cell in the list of candidate cells.

18. The UE of claim 17, wherein the signaling is a downlink control information (DCI) signaling and comprises one or more of following information:
an indicator used to indicate the candidate cell in the list of candidate cells, which the UE is indicated to transmit the PRACH preamble to;
an indicator of a synchronization signal/physical broadcast channel (SS/PBCH) of a cell;
an indicator of a random access preamble index;
an indicator of a PRACH mask index; and
an indicator used to indicate whether the PRACH preamble transmission is an initial transmission or a retransmission.

19. The UE of claim 18, wherein the DCI signaling is a DCI format 1_0 used for a random access procedure initiated by a physical downlink control channel (PDCCH)-order to the candidate cell in the list of candidate cells.

20. The UE of claim 17, wherein the UE is further configured to determine a power-ramping value associated with the PRACH preamble transmission.
